(19) United States
(12) Patent Application Publication
(10) Pub. No.: US 2015/0005063 A1
(43) Pub. Date: Jan. 1, 2015

(54) METHOD AND APPARATUS FOR PLAYING A GAME USING MEDIA ASSETS FROM A CONTENT MANAGEMENT SERVICE

(71) Applicant: Thomson Licensing, Issy de Moulineaux (FR)

(72) Inventor: Andra Lee, Valley Village, CA (US)

(21) Appl. No.: 13/929,010

(22) Filed: Jun. 27, 2013

(51) Int. Cl. A63F 13/30

(52) U.S. Cl. CPC A63F 13/12
USPC 463/31

(57) ABSTRACT

A game session between one or more users is played where the consumption habits of the one or more users determines the game questions that are used during the gaming sessions. Specifically, the one or more users utilize a content management service to consume various content such as video, audio, and the like. Based on the content consumed, a profile is generated for each user and the game questions are then selected based on the information in the generated user profiles.

### FIELD OF THE INVENTION

The invention concerns running a game between different users, specifically where the presentation of the game depends on past media that users have consumed using a content management service.

### BACKGROUND OF THE INVENTION

When a user consumes content using a content management service which lets a user stream or purchase different movies, television shows, music, and the like, the user typically has a profile that is generated about the user based on the consumption habits of the use of such a content management service. The generated profile is then used to suggest further content that is similar to content that the user has already consumed. Such recommendations are not typically used for other activities in which a user can participate in with their friends or other users who use a particular content management service.

### SUMMARY OF THE INVENTION

According to one aspect of the present disclosure, a method and apparatus is disclosed for enabling a game session for one or more users. The game session will be based on the content that such one or more users have consumed while using a content management service. The game session will present questions that are selected because the questions are related to content consumed by the one or more users.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering content to a user in accordance with the principles of the present disclosure;

FIG. 2 presents a block diagram of a system that presents an arrangement of media servers, online social networks, and consuming devices for consuming media in accordance with the principles of the present disclosure;

FIG. 3 shows a block diagram of an embodiment of a set top box/digital video recorder in accordance with the principles of the present disclosure;

FIG. 4 presents a block diagram of an exemplary content management service as implemented in a server in accordance with the exemplary principles of the present disclosure;

FIG. 5 presents a user interface displaying user profile information in accordance with the exemplary principles of the present disclosure;

FIG. 6 presents a user interface displaying a game in accordance with the exemplary principles of the present disclosure;

FIG. 7 presents a flowchart for a method for enabling a game in accordance with the exemplary principles of the present disclosure.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Using inventive concepts, the principles discussed below present a scenario where users play a game based on their media consuming habits using communication medium such as online social networks such as Facebook, LinkedIn, and the like and content management systems such as M-GO, Netflix, Amazon Digital Services, and the like.

The term online social network (OSN) can also be defined as an architecture that allows a first user to communicate with one or more users, without having to send a unique message to each user. That is, in the social network, there is efficiency in how messages are communicated to such users. In addition, social networks typically have a feature in where users permissively indicate whether or not they want to be “linked” to a second user. This type of feature can be implemented where a first user adds a second user to their list. The social networking site can then recommend other users that the first user knows, which would be presented with the list of users that are on a list controlled by the second user. The social network of the first user can be expanded upon the contacts in the individuals in the second list.

Within the description below, the principles of the present invention provide mechanisms for a user to transmit to their social network various information about the assets that the user is consuming. This fosters new ways of social interaction such as virtual group viewing, rating, recommending etc. Specifically, when using a consuming device such as a phone, tablet, set top box, video game system, digital video recorder, personal computer, and the like, a user can indicate what media is consumed (viewed/listened to/interacting with) while using the consuming device. Media that is consumed by a user while using a consuming device can be tracked by a content management service as to determine the preferences and consumption habits of the user.

Different fields are introduced below where such fields are used to indicate different properties about a media asset. The fields are described in this application are detonated by the use of a “tag” in the form of <<FIELD>>. Particular attributes for such fields can be added using various separations as indicated <<FIELD &ATTRIBUTE1 &ATTRIBUTE2 &ATTRIBUTE3 . . . >. It is understood that fields and attributes can also be constructed where a particular hash combination (MD5, SHA1, and the like) can represent the contents of a field and associated attributes. Other implementations can be performed in accordance with the principles of the present invention.

TABLE 1

| | |
|---|---|
| <<SERVICE ID> | This field represents a particular social networking |
| | service or other messaging medium that can be used. |
| &FACEBOOK | Facebook |
| &TWITTER | Twitter |
| &LINKEDIN | Linked-In |
| &FLICKER | Flicker Photo Sharing |
| &QZONE | Q-Zone |
| &MYSPACE | MySpace |
| &BEBO | Bebo |
| &SMS | Text Messaging Service |
| &USERNAME | User Name of a person using a social networking |
| | service |

TABLE 2

| | |
|---|---|
| <<ASSETID>> | This field represents the “name” of the |
| | media asset which is used for identifying the |
| | particular asset |
| &UUID | A universal unique identifier that is used for the |
| | media asset. This can be a unique MD5, SHA1, |
| | other type of hash, or other type of identifier |
| &NAME | A text name for the media asset |
| &TIME | Time that a media asset is being accessed. This |
| | information can be seconds, hours, days, day of |
| | the week, date, and other time related information |
| &ASSETCOMPLETE | The % of completion in the consumption of an |
| | asset |

The term media asset or media content (as described below for TABLE 3) can be: a video based media, an audio based media, a television show, a movie, an interactive service, a video game, a HTML based web page, a video on demand, an audio/video broadcast, a radio program, advertisement, a podcast, and the like.

TABLE 3

| | |
|---|---|
| <<ASSETTYPE> | This field represents the type of asset |
| | that is being communicated to a user of |
| | a social networking website. |
| &VIDEO | Video based asset |
| &AUDIO | Audio based asset |
| &PHOTO | Photo based asset |
| &TELEVISION | Television show asset which can be audio, video, |
| | or a combination of both |
| &MOVIE | Movie asset which can be audio, video, |
| | or a combination of both |
| &HTML | HTML based web page |
| &PREVIEW | Trailer which can be audio, video, |
| | or a combination of both |
| &ADMOVE | Advertisement asset - expected to be video and/or |
| | audio based such as a flash animation, H.264 video, |
| | SVC video, and the like. |
| &ADSTAT | Advertisement asset - expected to be a static image |
| | such as a JPG, PNG, and the like that can be used |
| | as a banner ad |
| &TEXT | Text Message |
| &RADIO | An audio asset that comes from terrestrial |
| | and/or satellite radio |
| &GAME | Game asset. |
| &INTERACTIVE | An interactive based media asset |
| &PODCAST | Podcast that is audio, video, or a combination of both |
| &APPLICATION | Indicates that a user utilized a particular type of |
| | application or accessed a particular service |

TABLE 4

| | |
|---|---|
| <<LOCATION> | This field represents the location of a particular |
| | media asset |
| &URL | The location of a media asset expressed as a |
| | uniform resource locator and/or IP address |
| &PATH\PATH... | The location of a media asset expressed as a |
| | particular local or remote path which can have |
| | multiple subdirectories. |
| &REMOTE | The location of a media asset in a remote location |
| | which would be specified by text after the remote |
| | attribute. |
| &LOCAL | The location of a media asset in a local location |
| | which would be specified by text after the remote |
| | attribute. |
| &BROADCAST | The location being a broadcast source such as |
| | satellite, broadcast television channel, cable |
| | channel, radio station, and the like |
| &BROADCASTID | The identifier of the broadcast channel used for |
| | transmitting a media asset, and the like |
| &SERVICE | Identification of a content management service for |
| | which a media asset can originate (as a content |
| | source or content provider). Content management |
| | services include M-GO, NETFLIX, AMAZON, |
| | and the like. |
| &SERVICELOCKER | Identification of a “digital locker” that is |
| | managed or associated with a content manage- |
| | ment service. For example, M-GO can operate a |
| | digital locker service associated with the |
| | ULTRAVIOLET digital format in which media |
| | content is stored and accessed. Other digital |
| | formats and storage lockers can be utilized as |
| | well with other content management services. |

TABLE 5

| | |
|---|---|
| <<PARENTALRATING>> | Parental Rating Information that is used |
| | to rate a particular media asset. Different |
| | parental ratings that can be used include Y, |
| | Y7, G, PG, 14 and MA. Other systems can |
| | be used. |
| <<CONTENTRATING> | A content rating that assigns a particular |
| | value to a media asset which is the critic |
| | rating of content. Typically, this is denoted |
| | as how many stars a movie has received. |
| | Other numeric values (0-100) or letter grades |
| | (A, B, C, D and F) can be used as well. |

Systems for delivering various types of content and for providing online social networking services and content delivery to a user will be described.

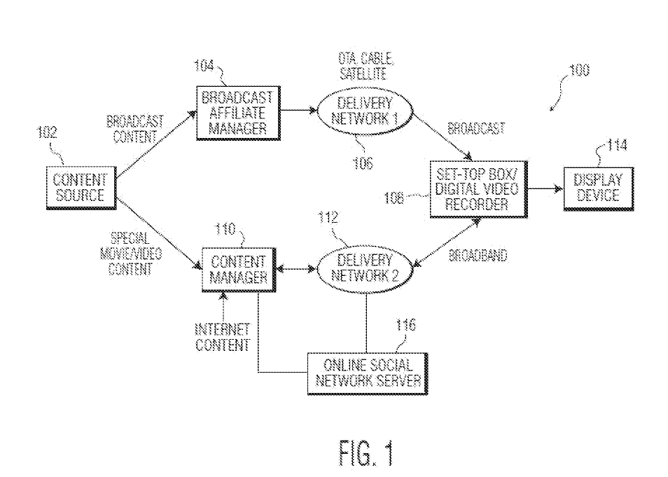

With reference to FIG. 1, a block diagram of an embodiment of a system 100 for delivering a media asset/content to a home or end user is shown. The content originates from a content source 102, such as a movie studio or production house. The content can be supplied in at least one of two forms. One form can be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager can collect and store the content, and can schedule delivery of the content over a deliver network, shown as delivery network 1 (106). Delivery network 1 (106) can include satellite link transmission from a national center to one or more regional or local centers. Delivery network 1 (106) can also include local content delivery using local delivery systems such as over the air broadcast, satellite broadcast, cable broadcast or from an external network via IP. The locally delivered content is provided to a user's set top box/digital video recorder (DVR) 108 in a user's home, where the content will subsequently be included in the body of available content that can be searched by the user.

A second form of content is referred to as special content. Special content can include content delivered as premium viewing, pay-per-view, video on demand, or other content not otherwise provided to the broadcast affiliate manager. In many cases, the special content can be content requested by a user on demand. The special content can be delivered via a content manager 110 which can be known as content management service as well. Content management service 110 can be a service provider, such as an Internet website, affiliated, for instance, with a content provider, broadcast service, or delivery network service. The content manager 110 can also incorporate Internet content into the delivery system, or explicitly into the search only such that content can be searched that has not yet been delivered to the user's set top box/digital video recorder 108. Content management service 110 can also be implemented as streaming on demand media provider such as M-GO, Netflix, Amazon Digital Services, and the like where a user can request different content from content manager 110 for a variety of consumption devices.

Optionally, content manager 110 is implemented with a content purchase module where a user can purchase audio and/or video based media which is then stored and made accessible via a digital locker from content management service 110. Content management service 110 can utilize a digital format such as ULTRAVIOLET, KEYCHEST, and the like where a user can store digital copies of purchased/owned media in a digital locker managed by content manager 110.

The content manager 110 can deliver the content to the user's set top box/digital video recorder 108 over a separate delivery network, delivery network 2 (112). Delivery network 2 (112) can include high-speed broadband Internet type communications systems. It is important to note that the content from the broadcast affiliate manager 104 can also be delivered using all or parts of delivery network 2 (112) and content from the content manager 110 can be delivered using all or parts of Delivery network 1 (106). In addition, the user can also obtain content directly from the Internet via delivery network 2 (112) without necessarily having the content managed by the content manager 110. In addition, the scope of the search goes beyond available content to content that can be broadcast or made available in the future.

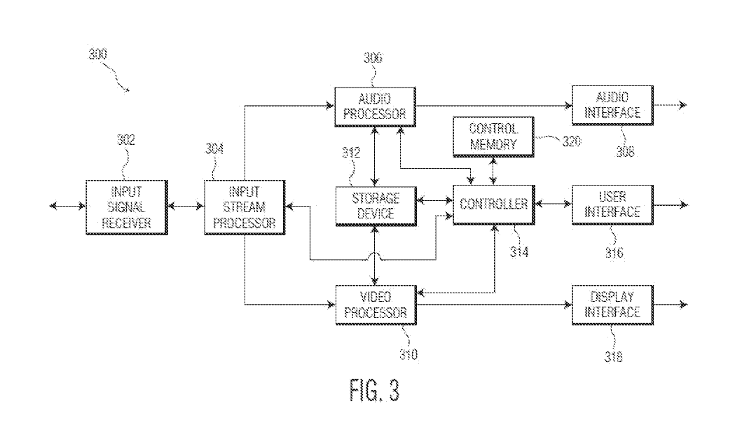

The set top box/digital video recorder 108, as a consumption device, can receive different types of content from one or both of delivery network 1 and delivery network 2. The set top box/digital video recorder 108 processes the content, and provides a separation of the content based on user preferences and commands. Set top box/digital video recorder 108 can also include a storage device, such as a hard drive or optical disk drive, for recording and playing back audio and video content. Further details of the operation of the set top box/digital video recorder 108 and features associated with playing back stored content will be described below in relation to FIG. 3. The processed content is provided to a display device 114. The display device 114 can be a conventional 2-D type display or can alternatively be an advanced 3-D display. It should be appreciated that other devices having display capabilities such as wireless phones, PDAs, computers, gaming platforms, remote controls, multi-media players, or the like, can employ the teachings of the present disclosure and are considered within the scope of the present disclosure.

Delivery network 2 is coupled to an online social network 116 which represents a website or server in which provides a social networking function. For instance, a user operating set top box 108 can access the online social network 116 to access electronic messages from other users, check into recommendations made by other users for content choices, see pictures posted by other users, refer to other websites that are available through the “Internet Content” path.

Online social network server 116 can also be connected with content manager 110 where information can be exchanged between both elements. Media that is selected for viewing on set top box 108 via content management service 110 can be referred to in an electronic message for online social networking 116 from this connection. This message can be posted to the status information of the consuming user who is viewing the media on set top box 108. That is, a user using set top box 108 can instruct that a command be issued from content manager 110 that indicates information such as the <<ASSETID>>, <<ASSETTYPE>>, and <<LOCATION>> of a particular media asset which can be in a message to online social networking server 116 listed in <<SERVICE ID>> for a particular user identified by &USERNAME.

Content management service 110 sends this information to the indicated social networking server 116 listed in the <<SERVICE ID>>, where an electronic message for &USERNAME has the information comporting to the <<ASSETID>>, <<ASSETTYPE>>, and <<LOCATION>> of the media asset posted to status information of the user. Other users who can access the social networking server 116 can read the status information of the consuming user to see what media the consuming user has viewed.

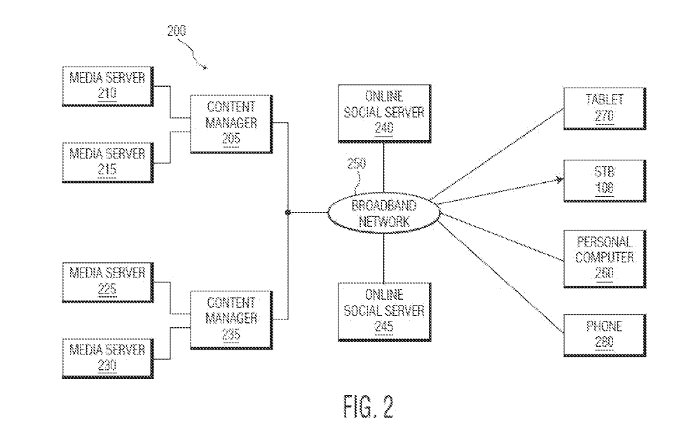

FIG. 2 presents an a block diagram of a system 200 that presents an arrangement of media servers, online social networks, and consuming devices for consuming media. Media servers 210, 215, 225, and 230 represent media servers where media is stored. Such media servers can be a hard drive, a plurality of hard drives, a server farm, a disc based storage device, and other type of mass storage device that is used for the delivery of media over a broadband network.

Media servers 210 and 215 are controlled by content manager/content management service 205. Likewise, media server 225 and 230 are controlled by content manager/content management service 235. In order to access the content on a media server, a user operating a consumption device such as STB 108, personal computer 260, table 270, and phone 280 can have a paid subscription for such content. The subscription can be managed through an arrangement with the content manager 235. For example, content manager 235 can be a service provider and a user who operates STB 108 has a subscription to programming from a movie channel and to a music subscription service where music can be transmitted to the user over broadband network 250. Content manager 235 manages the storage and delivery of the content that is delivered to STB 108. Likewise, other subscriptions can exist for other devices such as personal computer 260, tablet 270, and phone 280, and the like. It is noted that the subscriptions available through content manager 205 and 235 can overlap, where for example; the content comporting for a particular movie studio such as DISNEY can be available through both content managers. Likewise, both content managers 205 and 235 can have differences in available content, as well, for example content manager 205 can have sports programming from ESPN while content manager 235 makes available content that is from FOXSPORTS. Content managers 205 and 235 can also be content media services such as M-GO, NETFLIX, HULU, and the like who provide media assets where a user subscribes to such a content provider. An alternative name for such types of content providers is the term over the top service provider (OTT) which can be delivered “on top of” another service. For example, considering FIG. 1 content manager 110 provides internet access to a user operating set top box 108. An over the top service from content manager 205/235 (as in FIG. 2) can be delivered through the “internet content” connection, from content source 102, and the like.

By a content management service 205, 235, a subscription is not the only way that content can be authorized. Some content can be accessed freely through a content manager 205, 235 where the content manager does not charge any money for content to be accessed. Content manager 205, 235 can also charge for other content that is delivered as a video on demand for a single fee for a fixed period of viewing (# of hours). Content can be bought and stored to a user's device such as STB 108, personal computer 260, tablet 270, and the like where the content is received from content managers 205, 235. Other purchase, rental, digital locker storage, and subscription options for content managers 205, 235 can be utilized as well.

Online social servers 240, 245 represent the servers running online social networks that communicate through broadband network 250. Users operating a consuming device such as STB 108, personal computer 260, tablet 270, and phone 280 can interact with the online social servers 240, 245 through the device, and with other users. One feature about a social network that can be implemented is that users using different types of consumption devices (PCs, phones, tablets, STBs) can communicate with each other through a social network. For example, a first user can post messages to the account of a second user with both users using the same social network, even though the first user is using a phone 280 while a second user is using a personal computer 260. Broadband network 250, personal computer 260, tablet 270, and phone 280 are terms that are known in the art. For example, a phone 280 can be a mobile device that has Internet capability and the ability to engage in voice communications.

Turning now to FIG. 3, a block diagram of an embodiment of the core of a set top box/digital video recorder 300 as an exemplary consumption device is shown. Device 300 shown can also be incorporated into other systems including the display device 114. In either case, several components necessary for complete operation of the system are not shown in the interest of conciseness, as they are well known to those skilled in the art.

In the device 300 shown in FIG. 3, the content is received in an input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

Storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI). It is to be appreciated that the display interface 318 will generate the various screens for presenting the search results in a three dimensional array as will be described in more detail below.

Controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 316 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

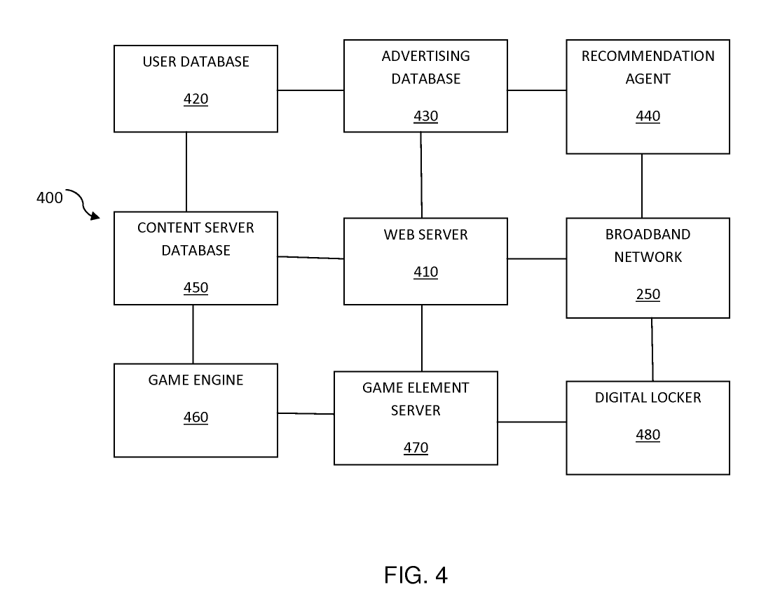

FIG. 4 presents a block diagram of a content management service 400 as an exemplary example of content management service 205, 235. Content manager 400 has a web server 410 that is capable of generating web pages in HTML, JAVA, and the like for viewing on a consuming device. Web server 410 can also be implemented as running as an application server enabling an application for delivering media content run to a user's device, and the application server handles the various application calls between the application and the back end running on a content server 450 which can operate through the connection of broadband network 250.

User database 420 stores information about the various users that use content management service 400. Such information can include biographical information about the user, specific interests selected by the user, information about the other users that are linked to the user, and the like. Advertising database 430 contains various ads that are delivered to the user when using online social network 400. Different types of ads that can be delivered include text, pictures, graphic files, banners, audio, video, animations, and the like.

Recommendation agent 440 is a computer program that is run for content manager 400 that makes various recommendations to a user. Such recommendations can be other users that the user should consider linking to, advertisements that user can be interested in, content the user can be interested in, and the like. Typically, a recommendation agent will use a mathematically developed model that finds correlations between various topics or subjects, where various behaviors of a user impact what will be recommendation. For example, the recommendation model can be built around a series of business rules where a user with the demographic of being a young male will have video game advertisements suggested to them, while a young female child can have advertisements suggested to her concerning educational products.

Content server/database 450 contains various media that can be delivered to a user. Content database 450 can also be implemented where various subscriptions of content are managed for different users.

Game engine 460 can be implemented as a server, computer program, and the like that provides a game for different users to play where such a game is based on the content such users have consumed using content management service 400. A game operated by game engine 460 can be played as series of questions/answers, video clips, audio clips, pictures, and the like that are presented to users. The different users then compete between each other in a quiz to get the right answer for a question in the shortest amount of time. A score can be attributed to correct answers and how timely a user is when answering a question correctly. Scores are tabulated whereby the user with the largest score wins. Other versions of game can also be utilized in accordance with the exemplary embodiments.

Game elements 470 is a database or a server which contains various questions, video clips, audio clips, pictures, and the like that are utilized by game engine 460 during a game. Ideally, game elements 470 is prepopulated with a large database of questions and corresponding answer choices which pertain to content from content management service 400. Game elements 470 can be updated as content is added and/or removed from content management service 400. Digital locker 480 is used to store and manage content of users that is purchased/uploaded to content management service 440. Digital locker 480 can be implemented using a system such ULTRAVIOLET, KEYCHEST, and the like.

In an exemplary embodiment of the present disclosure, game engine 460 selects various game elements 470 in view of content that is consumed by a single user or a plurality of users when using content manager 400. In this embodiment, a profile is kept for each content management user which the profile tracks all of the content a user has consumed using content management service 400. The profile can be used to list metadata that corresponds to the actors, director, title of content, producers of content, genres of content, content creators, and the like of content that was consumed by user(s). The metadata of consumed media from all of the profiles of a users competing in a game gets matched against the metadata of game elements 470 where matching game elements are used as the basis of questions for a game by game engine 460. For example, if a first user watched the movie “ROCKY” and a second user watched the movie “COBRA” using a content manager 400, metadata for the actor Sylvester Stallone can be used as the basis of questions selected from game elements 470 by game engine 460.

Other implementations of game engine 460 and game elements 470 are possible in accordance with the described exemplary principles where media stored in digital locker 480 is used as the basis of questions for a game between different users of content management service 400. The contents of digital locker 480 can be from a single user or a plurality of users. In addition, the basis of questions for a game from game engine 460 and game elements 470 can be from the content consumed from different users and the content owed by such users in digital locker 480.

In an alternative exemplary embodiment, the social networking services uses by different users are data mined in order to determine the various content consumed by such users. For example, a user's posting of a movie such as “Rocky” could be used as the basis to present game elements 470 during a game. In a second alternative embodiment, a user's consumption device can be searched to determine what content is present on such a device using a content searching program. Identified content that is found can also be used for the selection of game elements 470 in accordance with the principles described above.

In an exemplary embodiment, game engine 460 and game elements 470 exist separately from content management service 400, where game engine 460 and game elements 470 are contacted through broadband network 250.

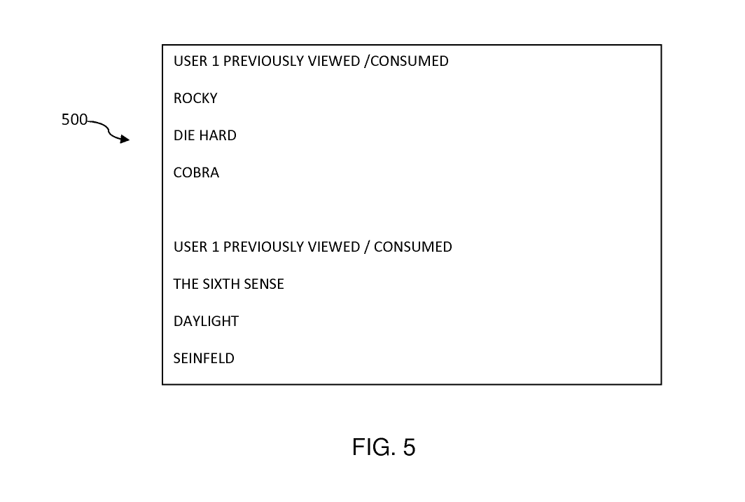

FIG. 5 represents a user interface 500 in accordance with an exemplary embodiment of the present principles. Specifically, user interface 500 demonstrates a screen shot of a game from game engine 460 which shows information concerning media previously consumed by two players (user 1 and user 2 respectively) who are playing in a game. Using the profile information that can be generated from a content management service 400, user 1 consumed movies such as “Rocky”, “Die Hard”, and “Cobra”. User 2 previously watched movies such as “The Sixth Sense”, “Daylight”, and “Seinfeld”. The movie information from the profiles of user 1 and user 2 can then be used to select different game elements 470 which concern the movies themselves, actors in the movies, directors of the movies, and the like.

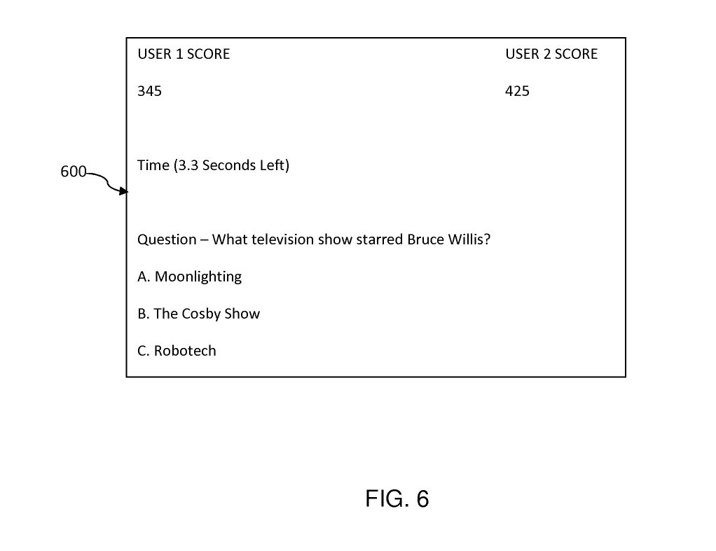

FIG. 6 represents a user interface 600 in accordance with an exemplary embodiment of the present principles. User interface 600 displays a question about an Bruce Willis who was an actor who starred in a movie consumed by user 1 “Die Hard” and user 2 “The Sixth Sense”, were such a question is selected from game elements 470. Specifically, there is a question in game element 470 that has metadata concerning Bruce Willis, whereby this ends up being presented during the game between user 1 and user 2. Other examples of game elements and how games can be played can be implemented in accordance with the exemplary principles.

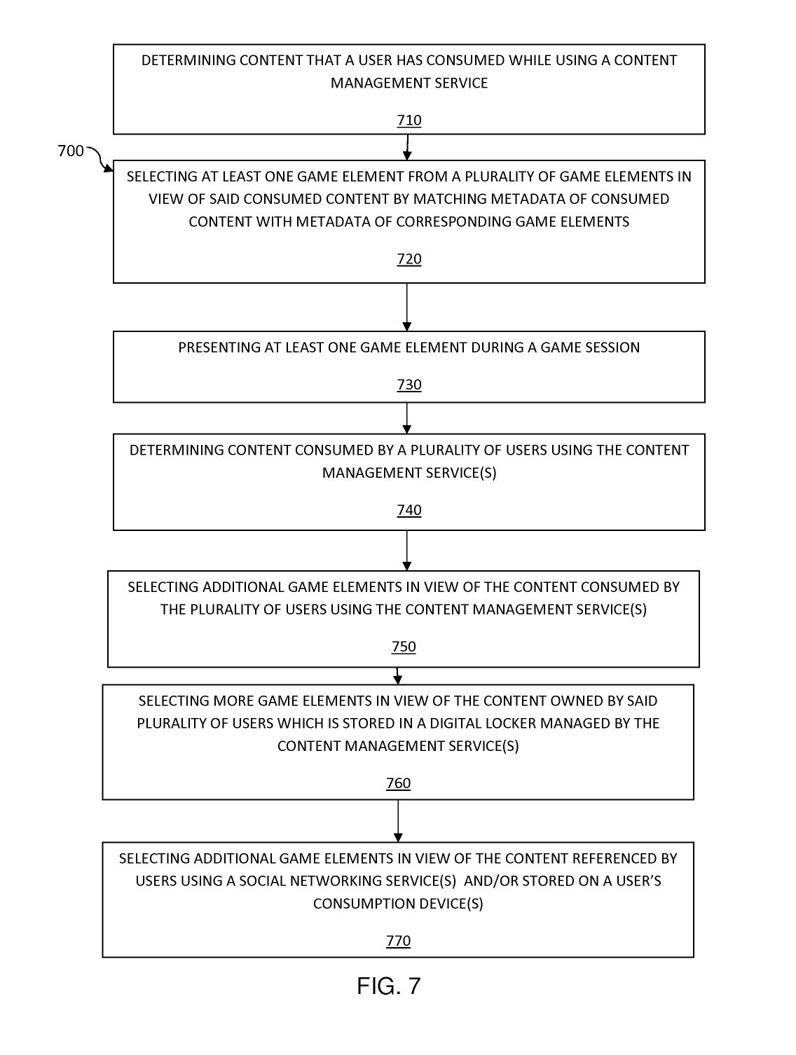

FIG. 7 is a flowchart of method 700 for implementing a game based on the content consumed by at least one user using an exemplary content management service. In step 710, a determination is made by a content management service to determine that content that user consumed using such a management service. The content consumption information can be used to construct a user profile for a user. Step 720 has a selection of at least one game element from a database where the game element has metadata that corresponds to media content consumed by a user. The selected game element in then used in a game session in step 730 in accordance with the exemplary principles presented.

Step 740 expands on previous steps by considering content consumed by a plurality of users using the content management service. Additional game elements for a game in which those plurality of users are participating are selected in step 750.

Step 760 presents an optional step where game elements that are presented during a game are selected in view of the content owned by a plurality of users where such content is stored on a digital locker maintained by the content management service. Step 770 presents a variation of the present principles where additional game elements are selected in view of content referenced by users in a social networking service and/or game elements are selected in view of the content stored on a user's device or devices.

1. A method comprising:
determining at least one content a user has consumed from a content management service;
selecting at least one game element from a plurality of game elements in view of said at least one content consumed; and
presenting said at least one game element to said user in a game session.

2. The method of claim 1 further comprising:
determining an additional at least one media content that a plurality of users consumed from said content management service, said plurality of users are participating in said game session with said user;
selecting an additional at least one game element from said plurality of game elements in view of said additional at least one media content consumed by said plurality of users; and
presenting said additional at least one game element in said game session to said user and said plurality of users.

3. The method of claim 2 comprising the additional steps of:
determining at least one content that said user and said plurality of users consumed from a plurality of content management services including said content management service.
selecting a second additional at least one game element from said plurality of game elements in view of said content that was consumed from said plurality of content management services; and
presenting said second additional at least one game element in said game session to said user and plurality of users.

4. The method of claim 1 where said at least one game element is at least one of: audio, video, picture, sound clip, and movie clip.

5. The method of claim 1:
said determination step also includes a determination of at least one content that said user owns which is located at least one of: a consumption device, a digital locker, a cloud based storage, and a server; and
said selecting step chooses said at least one game element in view of said at least one content consumed and said at least content that said user owns.

6. The method of claim 2 additionally comprises the steps of:
determining respective content owned by said user and each of said plurality of users, where said owned content is stored in a digital locker operated by said content management service;
selecting a second additional at least one game element from said plurality of game elements in view of said determination of said content owned by said user and each of said plurality of users; and
presenting said second additional at least one game element in said game session to said user and said plurality of users.

7. The method of claim 1:
said selecting step uses metadata from said content consumed in order to conduct a search for matching metadata of said at least one game element, results yielded from the search are at least one matching game element; and
said presented at least one game element is selected from said at least one matching game element.

8. The method of claim 7 where the metadata used for said search operation comports to at least one of actor, director, title of content, producer of content, genre of content, and content creator.

9. The method of claim 1
said selecting step uses metadata corresponding to a metadata of media content referenced by a user on a social networking service in order to conduct a search for matching metadata of said at least one game element, results yielded from the search are at least one matching game element; and
said presented at least one game element is selected from said at least one matching game element.

10. An apparatus comprising:
a processor; and
a memory storing instructions, when executed, cause the apparatus to:
determine at least one content a user has consumed from a content management service;
select at least one game element from a plurality of game elements in view of said at least one content consumed; and
display said at least one game element to said user in a game session.
